(19) United States
(12) Patent Application Publication
(10) Pub. No.: US 2022/0000080 A1
(43) Pub. Date: Jan. 6, 2022

(54) MEASUREMENT INSTRUMENT

(71) Applicant: Scale Aquaculture AS, Kverva (NO)

(72) Inventor: Ragnvald Inge Otterlei, Averøy (NO)

(21) Appl. No.: 17/291,404

(22) PCT Filed: Nov. 1, 2019
(86) PCT No.: PCT/NO2019/050237

§ 371 Date: May 5, 2021

(51) Int. Cl. A01K 61/80; G01N 21/359; G01N 21/85

(52) U.S. Cl. CPC A01K 61/80; G01N 21/85; G01N 21/359

(57) ABSTRACT

The invention relates to a solution that enables optimized regulation of feeding rates in aquaculture systems. The invention involves a feed detector shaped as a pipe segment that can be directly installed as a pipe socket in an outlet pipe of an aquaculture system. The feed detector comprises a pipe segment, radiation means and detection means.

### BACKGROUND

The disclosure relates to a device, method and system that enables optimized regulation of feeding rates in aquaculture systems.

Overfeeding in aquaculture systems is considered a large problem in the field of fish farming, as it results in elevated feeding costs and additional amount of drainage. Overfeeding is often a result of the fear of underfeeding, which results in reduced growth rates for the fish stock and accompanying costs.

Existing solutions for how to avoid overfeeding in fish farming involves e.g., submerging cameras in the fish tank/pen in order to monitor the amount of feed pellets that sink to the bottom of the fish tank/pen, and the rate at which feed pellets sink. In situ manual observations from these cameras are then used to adjust the rate at which feed pellets are added to the fish tank/pen.

A problem with existing solutions however is that they are inaccurate, require a high amount of manual labour, and that they require external fragile equipment. It is a goal of the present invention to provide an improved solution for how to optimize feeding rates in aquaculture systems.

### SUMMARY OF THE INVENTION

In a first aspect of the present invention, the invention provides pipe segment feed pellet detection assembly comprising a pipe segment with a pipe segment wall and a pipe segment hollow interior, radiation means, configured to radiate electromagnetic radiation into the pipe segment hollow interior, and detection means, configured to detect electromagnetic radiation from the pipe segment hollow interior.

According to an embodiment of the invention the radiation means may be mounted adjacent to an inner surface of the pipe segment wall, and the detection means may be mounted adjacent to the inner surface of the pipe segment wall.

According to another embodiment of the invention the radiation means may be mounted as a part of the pipe segment wall, and the detection means may be mounted as a part of the pipe segment wall.

According to yet another embodiment of the invention the pipe segment wall may further comprise at least one transparent portion, where the radiation means is mounted adjacent to an outer surface of the pipe segment wall, and configured to radiate electromagnetic radiation into the pipe segment hollow interior through one or more of the at least one transparent portion of the pipe segment wall, and where the detection means is mounted adjacent to the outer surface of the pipe segment wall, and configured to detect electromagnetic radiation from the pipe segment hollow interior through one or more of the at least one transparent portion of the pipe segment wall. The pipe segment wall may comprise one or two transparent portions.

According to yet another embodiment of the invention the pipe segment feed pellet detection assembly may further comprise at least one water tight cover that envelops at least one axial segment of the pipe segment, thereby covering at least one of the radiation means and detection means, and forms a water tight seal against the outer surface of the pipe segment.

According to yet another embodiment of the invention the detection means may have a curved shape and at least partially encloses a section of the pipe segment.

According to yet another embodiment of the invention the radiation means and detection means may be mounted on at least partially opposite sides of a central of the pipe segment.

According to yet another embodiment of the invention the pipe segment may have an essentially circular cross section, and the radiation means and detection means may be mounted at least partially antipodal of the central axis of the pipe segment.

According to yet another embodiment of the invention the pipe segment may be fitted with a coupling at least at one end.

According to yet another embodiment of the invention the radiation means may be configured to illuminate at least partly divergent electromagnetic radiation into the pipe segment hollow interior. The radiation means may alternatively be configured to illuminate an essentially collimated beam of electromagnetic radiation into the pipe segment hollow interior, and the detection means may be mounted in the beam path of the essentially collimated beam of electromagnetic radiation.

According to yet another embodiment of the invention a lens may be mounted in front of the detection means. The detection means may comprise a CCD screen. The detection means may be multispectral or hyperspectral detection means.

According to yet another embodiment of the invention the hollow interior of the pipe segment may have a rectangular cross section.

According to yet another embodiment of the invention the radiation means may be configured to radiate at least one of the types of electromagnetic radiation chosen from the group comprising multi-wavelength light, infrared light, ultraviolet light, white light, x-rays and monochromatic light.

According to yet another embodiment of the invention the pipe segment feed pellet detection assembly may further comprise additional radiation means, configured to radiate electromagnetic radiation into the pipe segment hollow interior, and additional detection means, configured to detect electromagnetic radiation from the pipe segment hollow interior.

According to yet another embodiment of the invention the additional radiation means may be mounted adjacent to the outer surface of the pipe segment wall, and may be configured to radiate electromagnetic radiation into the pipe segment hollow interior through one or more of the at least one transparent portion of the pipe segment wall, the additional detection means may be mounted adjacent to the outer surface of the pipe segment wall, and be configured to detect electromagnetic radiation from the pipe segment hollow interior through one or more of the at least one transparent portion of the pipe segment wall, and the additional radiation means and additional detection means may be mounted on at least partially opposite sides of the pipe segment, and be arranged perpendicularly to the arrangement of the radiation means and detection means.

In a second aspect of the present invention, the invention provides a fish feeding system comprising an aquaculture system comprising an aquaculture system main tank and an aquaculture system main tank outlet pipe, and a pipe segment feed pellet detection assembly according to any embodiment of the first aspect of the invention, where the pipe segment feed pellet detection assembly is mounted as a pipe segment of the main tank outlet pipe.

According to one embodiment of the invention the main tank outlet pipe may be branched, and the pipe segment feed pellet detection assembly may be mounted as a pipe segment of a branch of the main tank outlet pipe.

The fish feeding system may according to an embodiment of the invention further comprise a feeder configured to add feed pellets to the aquaculture system main tank, and a computer at least connected with the pipe segment feed pellet detection assembly and the feeder, configured to instruct the feeder based on at least one input from the pipe segment feed pellet detection assembly.

In a third aspect of the present invention, the invention provides a fish feeding method comprising the steps of providing a fish feeding system according to any embodiment of the second aspect of the invention, providing a fluid flow in the aquaculture system that passes through the pipe segment feed pellet detection assembly, adding, at a feeding rate by the feeder, feed pellets to the aquaculture system main tank, radiating, by radiation means of the pipe segment feed pellet detection assembly, electromagnetic radiation into the pipe segment hollow interior, detecting, by detection means of the pipe segment feed pellet detection assembly, electromagnetic radiation from the pipe segment hollow interior, estimating, by the computer, a number of feed pellets in the fluid flow passing through the pipe segment feed pellet detection assembly, and instructing, by the computer, the feeder to adjust the feeding rate based on the estimated number of feed pellets.

According to one embodiment of the invention the step of detecting electromagnetic radiation may comprise detection of real space images. The step of detecting electromagnetic radiation may comprise detection of reciprocal images. The step of detecting electromagnetic radiation may comprise detection of a spectral distribution of electromagnetic radiation.

Other advantageous features will be apparent from the accompanying claims.

### BRIEF DESCRIPTION OF THE DRAWINGS

In order to make the invention more readily understandable, the discussion that follows will refer to the accompanying drawings, in which:

FIG. 1 is a schematic representation of a pipe segment feed detection assembly comprising a transparent portion;

FIG. 2 is a schematic representation of an axial cross section of a pipe segment feed detection assembly;

FIG. 3 is a schematic representation of a pipe segment feed detection assembly comprising two transparent portions;

FIG. 4 is a schematic representation of a cross section of a pipe segment feed detection assembly comprising two transparent portions;

FIG. 5 is a schematic representation of a pipe segment feed detection assembly where at least one water tight cover covers the detection means and the radiation means;

FIG. 6 is a schematic representation of a pipe segment feed detection assembly comprising at least one coupling at one end;

FIG. 7 is a schematic representation of a cross section of a pipe segment feed detection assembly comprising curved detection means;

FIG. 8 is a schematic representation of a pipe segment feed detection assembly comprising a lens in front of detection means;

FIG. 9 is a schematic representation of a pipe segment feed detection assembly comprising a pipe segment with a rectangular pipe segment hollow interior cross section;

FIG. 10 is a schematic representation of a pipe segment feed detection assembly comprising additional radiation means and addition detection means;

FIG. 11 is a schematic representation of a fish feeding system comprising a pipe segment feed detection assembly;

FIG. 12 is a schematic representation of a fish feeding system comprising an aquaculture system with a branched outlet pipeᵢ

FIG. 13 is a schematic representation of a fish feeding method according to one embodiment of the invention;

FIG. 14 is a schematic representation of a pipe segment feed detection assembly where the pipe segment is U-shaped and where the radiation means irradiate electromagnetic radiation along the axial direction of a pipe segment;

FIG. 15 is a schematic representation of a pipe segment feed detection assembly comprising radiation means and detection means mounted adjacent to an inner surface of the pipe segment wall,

FIG. 16 is a schematic representation of a pipe segment feed detection assembly comprising additional radiation means and additional detection means mounted adjacent to an inner surface of the pipe segment wall, and

FIG. 17 is a schematic representation of a pipe segment feed detection assembly comprising radiation means and detection means mounted as a part of the pipe segment wall.

### DETAILED DESCRIPTION

In the following, general embodiments as well as particular exemplary embodiments of the invention will be described. References will be made to the accompanying drawings. It shall be noted, however, that the drawings are exemplary embodiments only, and that other features and embodiments may well be within the scope of the invention as claimed.

The present invention relates to a device, method and system that enable optimized regulation of feeding rates in aquaculture systems.

The present invention involves a pipe segment feed detector assembly that can be directly installed as a pipe socket in an outlet pipe of an aquaculture system. The pipe segment feed detector assembly detects uneaten feed pellets in the outlet flow from the aquaculture system and the number of uneaten feed pellets detected can subsequently be used to control the amount of feed added to the aquaculture system. The present invention can consequently be used to optimize feeding of fish in an aquaculture system, and thus to minimize feed spill.

In a first aspect of the present invention, the invention provides a pipe segment feed pellet detection assembly comprising a pipe segment, radiation means and detection means.

The pipe segment 110 of the pipe segment feed detection assembly 100 may as illustrated in FIG. 1 be pipe shaped with a pipe segment wall 120 and a pipe segment hollow interior 130. The pipe segment 110 may be straight, bent, U shaped, S shaped, or any arbitrary shape. FIG. 14 illustrates a pipe segment feed detection assembly 100 where the pipe segment 110 has a non-straight shape.

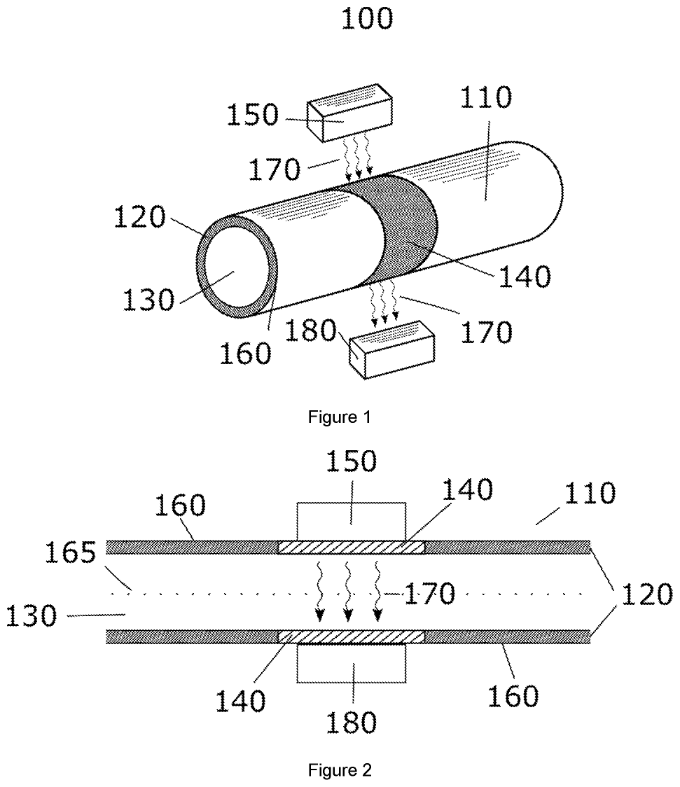

The radiation means 150 and detection means 180 of the pipe segment feed detection assembly may be mounted outside, inside or as a part of the pipe segment 110, as illustrated in FIGS. 2, 15 and 17 respectively. The radiation means and detection means 180 may be a part of the pipe segment wall 120, adjoining the outer surface 160 or inner surface 161 of the pipe segment wall 120 or positioned at a distance from the pipe segment wall 120.

FIG. 1 illustrates a pipe segment feed pellet detection assembly 100 where radiation means 150 is mounted radially adjacent to an outer surface 160 of the pipe segment wall 120. Here, the radiation means 150 is configured to radiate electromagnetic radiation 170 into the pipe segment hollow interior 130 through at least one transparent portion 140 of the pipe segment wall 120. The radiation means may thus be positioned in the vicinity of a transparent portion 140 of the pipe segment wall 120, e.g., adjacent to a transparent portion 140 of the pipe segment wall 120.

FIG. 1 is an illustration of a pipe segment feed pellet detection assembly 100 where detection means 180 is mounted radially adjacent to the outer surface 160 of the pipe segment wall 120. Here, the detection means 180 is configured to detect electromagnetic radiation 170 from within the pipe segment hollow interior 130 through one or more of the at least one transparent portion 140 of the pipe segment wall 120.

FIG. 1 illustrates a pipe segment feed detection assembly 100 where the pipe segment wall 120 comprises at least one transparent portion 140. Any transparent portion 140 can be a part of the pipe segment wall 120 or can be an inset, e.g., a window or equivalent. The transparency generally has to be non-zero for at least one type of electromagnetic radiation, i.e., electromagnetic radiation within a certain wavelength interval. The at least one transparent portion 140 may be configured to be transparent to at least parts of the radiation radiated by the radiation means 150.

Any transparent portion of the pipe segment feed detection assembly may according to the invention have an 80% or higher transparency for light in the visible region. Any transparent portion of the pipe segment feed detection assembly may alternatively or additionally have an 80% or higher transparency for light in the near infrared. The near infrared region may here be defined as lying between 780 nm and 1600 nm or alternatively between 780 nm and 1000nm.

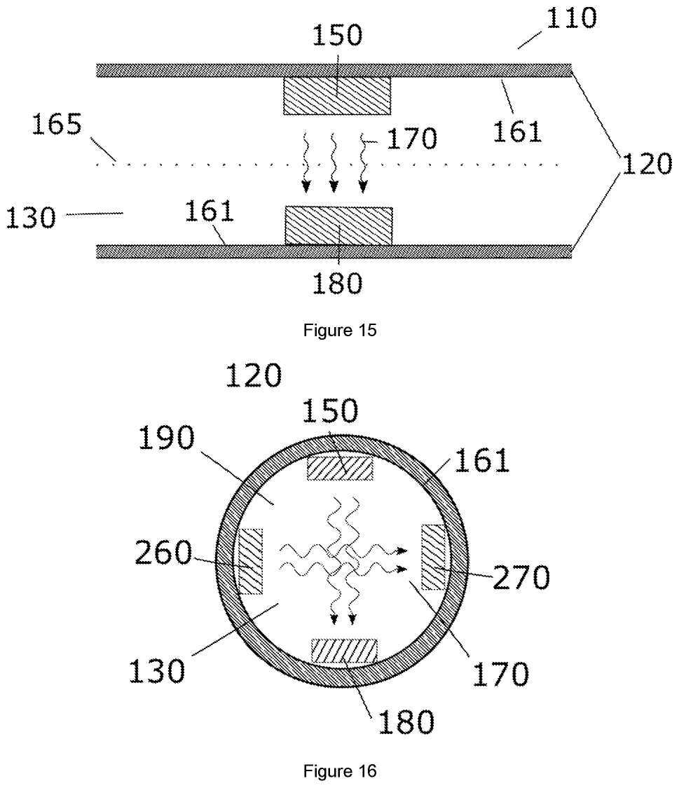

FIG. 15 illustrates a pipe segment feed detection assembly where the radiation means 150 and detection means 180 are mounted adjacent to an inner surface of the pipe segment wall. Here, the radiation means 150 is configured to radiate electromagnetic radiation 170 in the pipe segment hollow interior 130, while the detection means 180 is configured to detect electromagnetic radiation 170 in the pipe segment hollow interior 130.

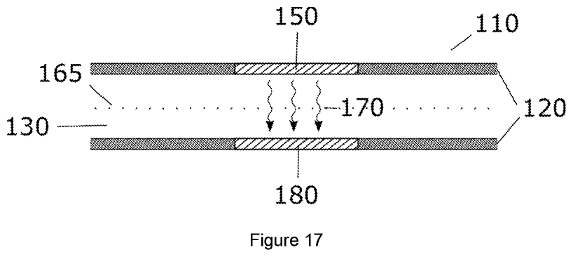

FIG. 17 illustrates a pipe segment feed detection assembly where the radiation means 150 and detection means 180 are mounted as a part of the pipe segment wall 120. Here, the radiation means 150 is configured to radiate electromagnetic radiation 170 in the pipe segment hollow interior 130, while the detection means 180 is configured to detect electromagnetic radiation 170 in the pipe segment hollow interior 130.

The electromagnetic radiation 170 detected by detection means may according to any embodiment of the present invention originate from the radiation means 150. The electromagnetic radiation may have been scattered, reflected or similar e.g., by pipe segment inner walls, or a fluid, fluid impurities, or objects within pipe segment hollow interior 130.

The detection means of the pipe segment feed detection assembly is according to the invention configured to detect radiation from the pipe segment hollow interior. The detected radiation typically originates from the radiation means or is generated indirectly from radiation originating from the radiation means. The detection means may according to the invention be a camera that comprises a CCD. The CCD may for example comprise a silicon, InGaAs or PbS-based CCD or a combination between a silicon based detector and an InGaAs or PbS-based detector. The detection means may comprise a line camera. The detection means 180 may be a multispectral or hyperspectral camera.

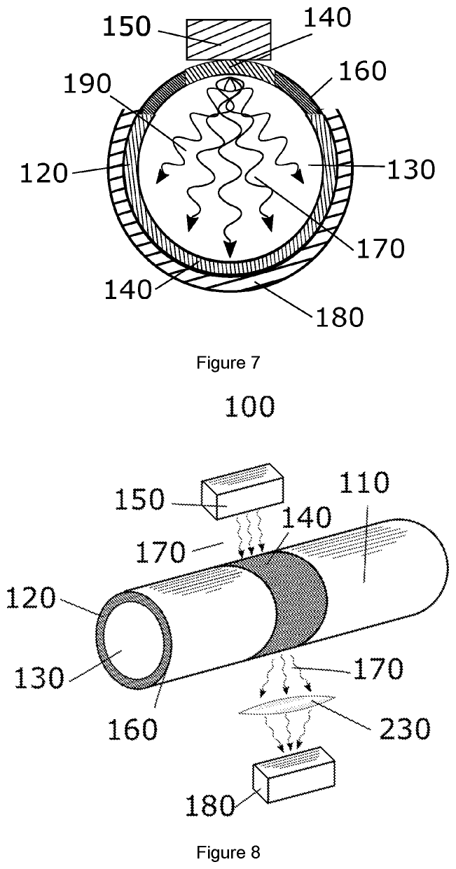

FIGS. 2, 15 and 17 illustrate a pipe segment feed detection assembly 100 where the radiation means 150 and detection means 180 are mounted on at least partially opposite sides of the pipe segment central axis 165. The positioning of the radiation means 150 and detection means 180 may generally be performed so that the detection means 180 is positioned in the path of radiation from the radiation means 150. The detection means 180 may alternatively be positioned in any position that enables detection of reflected radiation originating from the radiation means 150. The radiation means 150 and detection means 180 may as illustrated in FIG. 7 be positioned in a cross sectional plane of the pipe segment 110, but can also be positioned at axially different positions.

FIG. 1-0 illustrate a pipe segment 110 that comprises at least one transparent portion 140 so as to allow for electromagnetic radiation 170 to be radiated into and detected from within the pipe segment hollow interior 130. At least one transparent portion 140 may be aligned according to the radiation means 150. At least one transparent portion 140 may be aligned according to the detection means 180. The pipe segment 110 may according to the invention comprise any number of transparent portions 140.

FIG. 1 illustrates a pipe segment feed pellet detection assembly 100 comprising one transparent portion 140. In this case the transparent portion 140 at least partially stretches around the pipe segment hollow interior 130 so as to be positioned at least partly in front of both the radiation means 150 and the detection means 180.

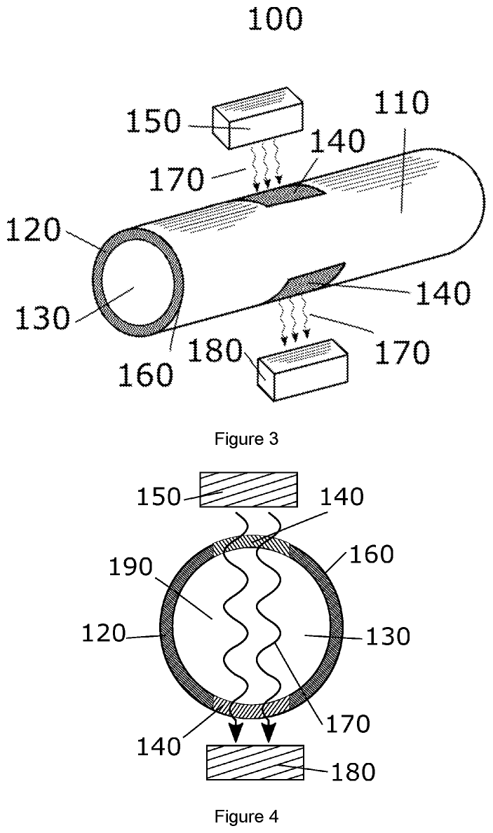

FIG. 3 illustrates a pipe segment feed pellet detection assembly 100 comprising two transparent portions 140. Here, the two transparent portions 140 are respectively aligned according to the position of the radiation means 150 and detection means 180. This alignment allows for electromagnetic radiation 170 from the radiation means 150 to enter the pipe segment hollow interior 130, and for electromagnetic radiation 170 from within the pipe segment hollow interior 130 to reach the detection means 180.

FIG. 4 illustrates a pipe segment feed pellet detection assembly 100 where the pipe segment has an essentially circular cross section 190. The radiation means 150 and detection means 180 are here mounted at least partially antipodal.

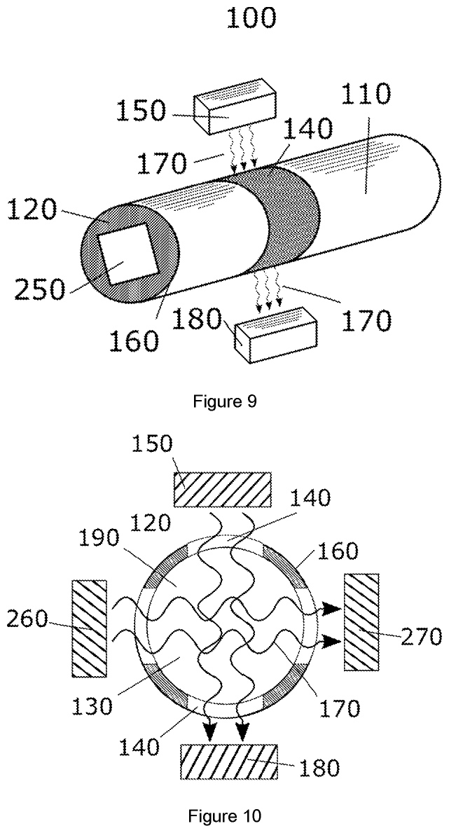

The pipe segment may in principle have a cross section with any two-dimensional shape. Such shapes are e.g., circular, elliptical, semi-circular, quadratic, quadrilateral, pentagonal and polygonal. FIG. 9 illustrates an embodiment of the invention where the pipe segment hollow interior 130 has a rectangular cross section 250. In this case the radiation means 150 and detection means 180 may be positioned adjacent to opposite sides of the cross section.

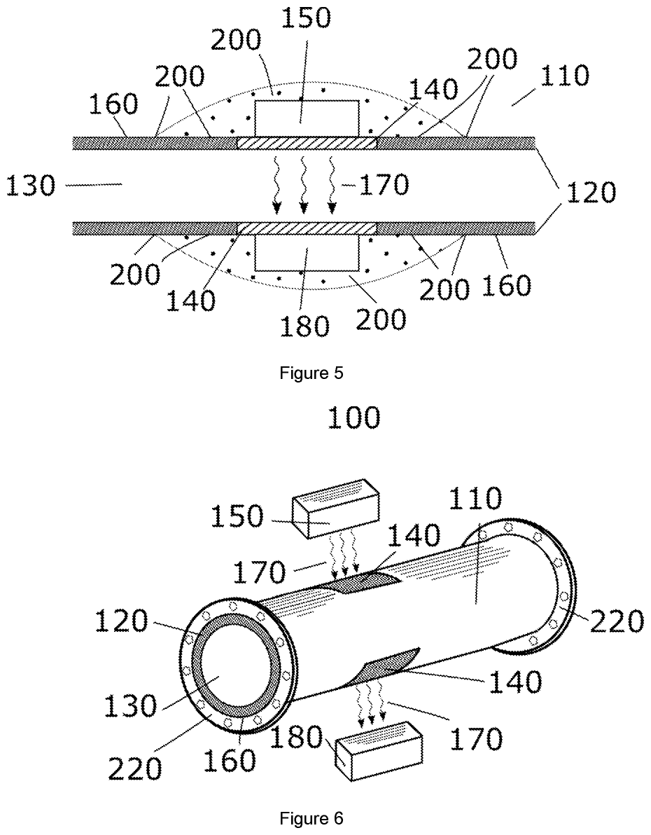

The pipe segment feed pellet detection assembly may according to the invention be used in combination with an aquaculture system, which may require that the feed pellet detection assembly have to be placed under water. According to one embodiment of the invention the pipe segment feed pellet detection assembly may thus comprise at least one water tight cover. The purpose of a cover is at least to protect the radiation means and detection means from the surrounding water, e.g., to avoid electric shorting, corrosion etc. A water tight cover 200 may as illustrated in FIG. 5 envelop at least one axial segment of the pipe segment 110 and cover at least one of the radiation means 150 and detection means 180. A water tight cover 200 may alternatively envelop at least one portion of the pipe segment 110 and cover both the radiation means 150 and detection means 180. Any water tight cover 200 may form a water tight seal 210 against a surface, e.g., the outer surface 160, of the pipe segment 110, i.e., a seal so that any one or both of the radiation means 150 and detection means 180 are sealed off from any surrounding water.

FIG. 6 illustrates a pipe segment feed pellet detection assembly 100 fitted with a coupling 220 at least at one end. The pipe segment feed pellet detection assembly 100 may in this case be fitted as a pipe socked in any existing pipe, e.g., that of an outlet pipe of a tank in an aquaculture system. The coupling 220 may be a flange coupling, clamp coupling, weld, or any other suitable coupling.

The radiation means is according to the invention configured to radiate electromagnetic radiation into at least a part of the pipe segment hollow interior. The radiated electromagnetic radiation may be divergent, collimated or a combination of both. The radiated electromagnetic radiation may pass through any number of lenses, filters and or grids. Examples of such are a focusing lens, defocusing lens, polarization filter, wavelength absorbance filter, diffraction grids. Any transparent portion of the pipe segment may according to the invention act as a lens, and hence be used in order to influence any electromagnetic radiation passing through. FIG. 8 illustrates a pipe segment feed detection assembly 100 where a lens 230 is mounted in front of detection means.

FIG. 7 illustrates a pipe segment feed pellet detection assembly 100 where the radiation means 150 radiates at least partly divergent electromagnetic radiation 170. Such divergent electromagnetic radiation 170 may be irradiated such that it arrives with a non-zero divergence at a transparent portion 140 of the pipe segment, or such that it has a non-zero divergence in the pipe segment hollow interior 130. The latter allows for a large proportion of the cross section of the pipe segment to be radiated.

FIG. 7 illustrates a pipe segment feed pellet detection assembly 100 where the detection means 180 has a curved shape. The detection means 180 may at least partially enclose a section of the pipe segment, and detect electromagnetic radiation 170 escaping the pipe segment hollow interior 130 in multiple directions. FIG. 7 illustrates a pipe segment feed pellet detection assembly 100 comprising curved detection means 180 where electromagnetic radiation 170 is radiated into the pipe section hollow interior 130 in a divergent manner.

The radiation means may according to one embodiment of the invention be configured to radiate an essentially collimated beam of electromagnetic radiation into the pipe segment hollow interior. The radiation means may in itself radiate a collimated beam of radiation or be used in combination with one or more lenses in order to create a collimated beam of radiation within the pipe segment hollow interior. Any transparent portion of the pipe segment may be utilized as a lens, e.g., in order to refract radiation entering the pipe segment hollow interior. FIG. 2 illustrates a pipe segment feed pellet detection assembly where electromagnetic radiation 170 is radiated into the pipe segment hollow interior 130 as a collimated beam of electromagnetic radiation 170. Detection means 180 may in this case be mounted in the beam path of the essentially collimated beam of electromagnetic radiation 170.

FIG. 8 illustrates a pipe segment feed pellet detection assembly 100 where a lens 230 is mounted in front of detection means 180. Any number of lenses may be used in order to refract or filter radiation before being detected by the detection means 180. The detection means 180 may be a CCD screen 240. The detection means 180 may be multispectral or hyperspectral detection means.

Detection means of the pipe segment feed detection assembly may according to the present invention be configured to capture an image from visible light. Detection means of the pipe segment feed detection assembly may optionally, or additionally be configured to capture an image from near infrared light.

A band pass filter may in the context of the invention be positioned in front of the detection means in order to e.g., improve the contrast between feed pellets and other substances, such as for example feces. The type of band pass filter may in this case be chosen based on the wavelengths that are desirable to detect by the detection means. The filter can for example be a visible light band pass filter or a near infrared band-pass filter.

The radiation means is according to the invention configured to radiate at least one type of electromagnetic radiation. The type of electromagnetic radiation may be chosen from the group comprising multi-wavelength light, infrared light, ultraviolet light, white light, x-rays and monochromatic light.

The radiation means may according to the invention be configured to radiate visible light, or alternatively a subset of wavelengths within the visible light region. Light with wavelengths in the range 350 nm to 550 nm may optionally be used due to its low absorption in water. Light in the near infrared region may alternatively be used in order to enhance contrast between uneaten feed pellets and other substances. The near infrared region may here be defined as including wavelengths between 780 and 1600 nm, but could according to the invention alternatively be considered as including wavelengths between 780 and 1000 nm. The radiation means may in the context of the present invention comprise one or more LEDs, or alternatively a combination of a light source together with one or more amongst a prism, a grid and a band pass filter for near infrared light or visible light.

FIGS. 10 and 16 illustrate a pipe segment feed pellet detection assembly comprising additional radiation means 260, and additional detection means 270. The additional radiation means 260 and additional detection means 270 may be configured in a similar manner as the radiation means 150 and detection means 180 according to any embodiment of the invention.

The additional radiation means 260 may according to one embodiment of the invention be mounted radially adjacent to the outer surface 160 of the pipe segment wall 120, and be configured to radiate electromagnetic radiation 170 into the pipe segment hollow interior 130 through one or more of the at least one transparent portion 140 of the pipe segment wall 120. The additional detection means 270 may be mounted radially adjacent to the outer surface 160 of the pipe segment wall 120, and be configured to detect electromagnetic radiation 170 from the pipe segment hollow interior 130 through one or more of the at least one transparent portion 140 of the pipe segment wall 120. The additional radiation means 260 and additional detection means 270 may be mounted on at least partially opposite sides of the pipe segment central axis and may be arranged perpendicularly to the arrangement of the radiation means 150 and detection means 180.

In a second aspect of the present invention, the invention provides a fish feeding system comprising an aquaculture system and a pipe segment feed pellet detection assembly.

The aquaculture system may according to the invention be a closed aquaculture system configured to be used for fish farming. The aquaculture system may comprise units like a main tank, oxygenation means, filtration means, pumps, outlet tubes, inlet tubes, flow controllers, etc.

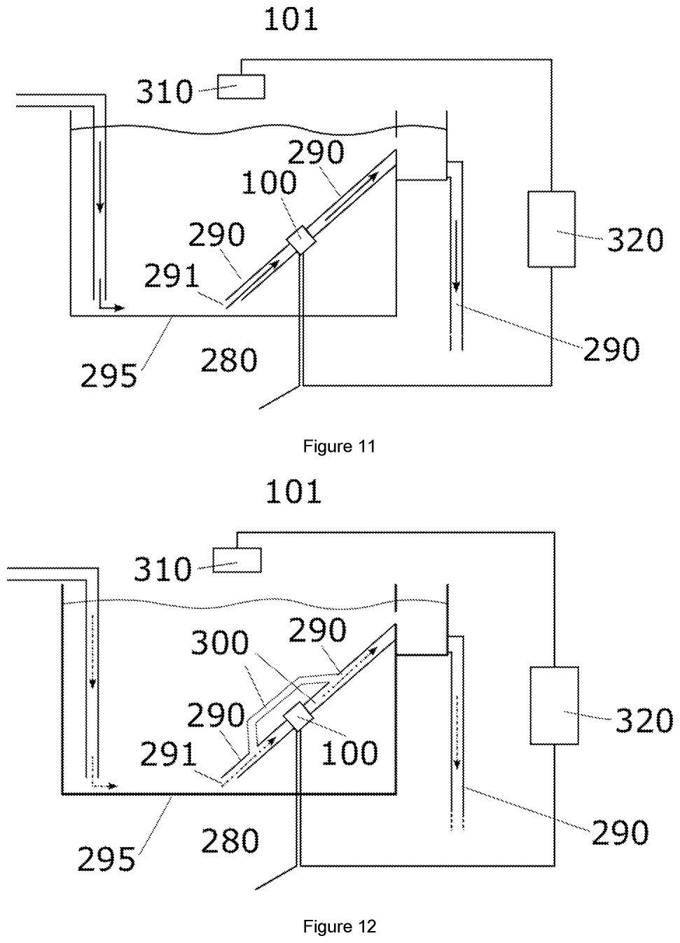

FIGS. 11 and 12 illustrates a fish feeding system 101. The fish feeding system 101 comprises according to the invention an aquaculture system 280 comprising an aquaculture system main tank 295 and an aquaculture system main tank outlet pipe 290. Here, a pipe segment feed pellet detection assembly 100 is mounted as a pipe segment of the main tank outlet pipe 290. The pipe segment feed pellet detection assembly 100 may be mounted in a variety of positions but should preferably be mounted downstream from the aquaculture system main tank 295 prior to any filtration means. The pipe segment feed pellet detection assembly 100 may optionally be mounted as a pipe segment of the main tank outlet pipe 290 as close as possible to, or at the outlet pipe entry point 291. The pipe segment feed pellet detection assembly 100 is according to one embodiment of the invention mounted as a part of the main tank outlet pipe 290. This could be as a part of one main tank outlet pipe 290 or alternatively as a part of one branch 300 of a branched main tank outlet pipe. The branch may optionally have an inner diameter of less than 10 cm, alternatively less than 5 cm, or alternatively less than 3 cm.

FIGS. 11 and 12 illustrates a fish feeding system 101, wherein the aquaculture system 280 further comprises a feeder 310 and a computer 320. Here, the feeder 310 may be configured to add feed pellets to the aquaculture system main tank 295, e.g., with a certain feeding rate. The computer 320 is according to one embodiment of the invention at least connected with the pipe segment feed pellet detection assembly 100 and the feeder 310, and is configured to send instructions to the feeder 310 based on at least one input from the pipe segment feed pellet detection assembly 100.

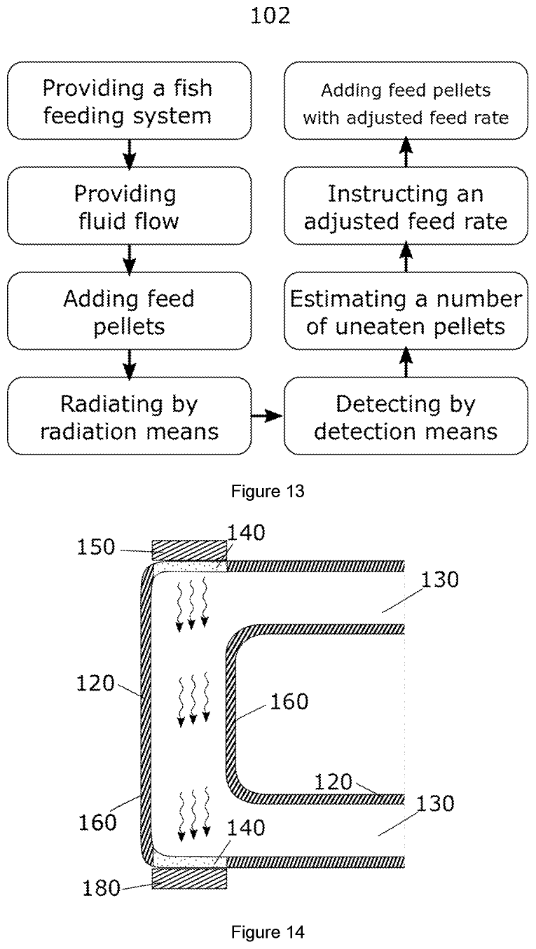

In a third aspect of the present invention, the invention provides a fish feeding method that aims at optimizing feeding in aquaculture systems. The method 102 is illustrated in FIG. 13 and is based on a pipe segment feed detection assembly that can be mounted as a part of an outlet pipe from an aquaculture system, and that detects uneaten feed pellets passing through the outlet pipe. Ideally, in order to minimize feed spill, the number of feed pellets passing through the outlet pipe should be as small as possible provided that the fish gets adequate amounts of food. A high number of uneaten feed pellets passing through the outlet pipe is a sign that there is added too much food to the fish tank in the aquaculture system.

The fish feeding method comprises a step of providing a fish feeding system as described earlier and a step of providing a flow in the aquaculture system. Such a flow, may be created by a pump and involves at least adding water to a main tank of the aquaculture system through e.g., an inlet pipe, and removing of water from the same tank through an outlet pipe. As a pipe segment feed detection assembly is connected as a part of the outlet pipe, a flow in the aquaculture system will create a flow of from the main tank of the aquaculture system through the pipe segment feed detection assembly.

The fish feeding method further comprise the step of adding at a feeding rate by a feeder, feed pellets to the aquaculture system main tank. At least a portion of the feed pellets will then subsequently be eaten by any fish in the aquaculture system main tank, and the rest will eventually be pumped out through the outlet pipe. Any uneaten feed pellet flowing through the outlet pipe may be detected by the pipe segment feed detection assembly.

In order to establish the number of uneaten feed pellets in the outlet pipe of the aquaculture system, the fish feeding method involves detection of feed pellets by the pipe segment feed detection assembly. The fish feeding method thus comprise a step of radiating by radiation means of the pipe segment feed pellet detection assembly, electromagnetic radiation into the pipe segment hollow interior. This electromagnetic radiation is subsequently scattered, reflected or absorbed dependent on what by material is present inside the pipe segment hollow interior, e.g., uneaten feed pellets. In order to obtain any information regarding the material present in the pipe segment hollow interior, the fish feeding method further comprise a step of detecting, by detection means of the pipe segment feed pellet detection assembly, electromagnetic radiation from the pipe segment hollow interior. This electromagnetic radiation contains information regarding the material in the pipe segment hollow interior, and can, in combination with information regarding e.g., the position of the detection means, radiation means, geometry of the pipe segment, flow profile in the outlet pipe and/or the flow rate in the outlet pipe, be used in order to estimate the number/amount of feed pellets passing through the outlet pipe per time. The estimation may e.g., be performed by a computer or general computing means. The fish feeding method thus further comprise a step of estimating, by a computer or computing means, a number/amount of feed pellets in the fluid flow passing through the pipe segment feed pellet detection assembly.

The radiation means may according to any embodiment of the present invention be configured to irradiate electromagnetic radiation into at least a fraction of the pipe segment, optionally at least a fraction of the cross section of the pipe segment. This enables sampling measurements to be performed, where the detected electromagnetic radiation is used in combination with an estimated or measured fluid distribution profile in the outlet pipe in order to estimate the number of or flow rate of feed pellets present in the pipe segment. The fluid flow in the pipe segment may for example be determined using a flow meter or any other suitable fluid flow measurement means. A camera may for example be used to measure the velocity with which a pellet passes through the pipe segment.

The number/amount of feed pellets in the fluid flow passing through the pipe segment feed pellet detection assembly is a measure of how much feed spill there is in the aquaculture system, and consequently a measure of how much excess feeding is being executed. The computer may therefore instruct the feeder to adjust the feeding rate based on the estimated number/amount of feed pellets in the fluid flow passing through the pipe segment feed pellet detection assembly.

According to one embodiment of the invention the step of detecting electromagnetic radiation may comprise detection of real space images. The step of detecting electromagnetic radiation may comprise detection of reciprocal images. The step of detecting electromagnetic radiation may comprise detection of a spectral distribution of electromagnetic radiation.

Feed pellets may according to the invention be detected via image analysis of one or more images captured using detection means of the pipe segment feed detection assembly. Feed pellets can for example be identified in an image from their characteristic size and/or shape, using e.g., a computer or other suitable image analysis means. Visible light may here be suitable for use in the capturing of an image due to its long penetration depth in water. Light with wavelengths in the range between 350 nm and 550 nm may optionally be used. The amount of feed pellets passing through the pipe segment per time may thus be estimated from the total number of pellets detected in an image and the fluid flow rate in the pipe segment.

Images may according to the invention be captured with a sample rate determined by the fluid flow rate in the pipe segment. The sample rate may e.g., be set such that each individual uneaten feed pellet passing through the pipe segment only appears in one single image, i.e., it does not appear in two consecutive images. This avoids in other words counting the same pellet twice.

Use of near infrared light may alternatively or optionally be used in order to enhance contrast between the feed pellets and other substances such as feces. This contrast difference has been found to originate from the difference in spectral signature between feed pellets and that of e.g., feces. Near infrared light may alternatively be used in order to detect the fat levels and/or protein levels in the fluid passing through the pipe segment, which subsequently can be used to estimate the number of feed pellets passing through the pipe segment per time.

Other advantageous features will be apparent from the accompanying claims.

| | |
|---|---|
| 100 | Pipe segment feed detection assembly |
| 101 | Fish feeding system |
| 102 | Fish feeding method |
| 110 | Pipe segment |
| 120 | Pipe segment wall |
| 130 | Pipe segment hollow interior |
| 140 | Transparent portion |
| 150 | Radiation means |
| 160 | Outer surface |
| 161 | Inner surface |
| 165 | Central axis |
| 170 | Electromagnetic radiation |
| 180 | Detection means |
| 190 | Circular cross section |
| 200 | Water tight cover |
| 210 | Water tight seal |
| 220 | Coupling |
| 230 | Lens |
| 240 | CCD screen |
| 250 | Rectangular cross section |
| 260 | Additional radiation means |
| 270 | Additional detection means |
| 280 | Aquaculture system |
| 290 | Aquaculture system main tank outlet pipe/main tank outlet pipe |
| 291 | Outlet pipe entry point |
| 295 | Aquaculture system main tank |
| 300 | Branch |
| 310 | Feeder |
| 320 | Computer |

1. A pipe segment feed pellet detection assembly comprising:
a pipe segment with a pipe segment wall and a pipe segment hollow interior,
radiation means, configured to radiate electromagnetic radiation into the pipe segment hollow interior, and
detection means, configured to detect electromagnetic radiation, comprising detection of real space images, reciprocal images or a spectral distribution of electromagnetic radiation, from the pipe segment hollow interior.

2. The pipe segment feed pellet detection assembly of claim 1, wherein:
the radiation means is mounted adjacent to an inner surface of the pipe segment wall, and where wherein
the detection means is mounted adjacent to the inner surface of the pipe segment wall.

3. The pipe segment feed pellet detection assembly of claim 1, wherein:
the radiation means is mounted as a part of the pipe segment wall, wherein
the detection means is mounted as a part of the pipe segment wall.

4. The pipe segment feed pellet detection assembly of claim 1 wherein:
the pipe segment wall comprises at least one transparent portion,
the radiation means is mounted adjacent to an outer surface of the pipe segment wall, and configured to radiate electromagnetic radiation into the pipe segment hollow interior through one or more of the at least one transparent portion of the pipe segment wall, wherein
the detection means is mounted adjacent to the outer surface of the pipe segment wall, and configured to detect electromagnetic radiation from the pipe segment hollow interior through one or more of the at least one transparent portion of the pipe segment wall.

5. The pipe segment feed pellet detection assembly of claim 4, wherein the pipe segment wall comprises one or two transparent portions.

6. The pipe segment feed pellet detection assembly of claim 4, further comprising at least one water tight cover that envelops at least one axial segment of the pipe segment, thereby covering at least one of the radiation means and detection means, and forms a water tight seal against the outer surface of the pipe segment.

7. The pipe segment feed pellet detection assembly of claim 4, wherein the detection means has a curved shape and at least partially encloses a section of the pipe segment.

8. The pipe segment feed pellet detection assembly of claim 1, wherein the radiation means and detection means are mounted on at least partially opposite sides of a central axis of the pipe segment.

9. The pipe segment feed pellet detection assembly of claim 1, wherein the pipe segment has an essentially circular cross section and where the radiation means and detection means are mounted at least partially antipodal of the central axis of the pipe segment.

10. The pipe segment feed pellet detection assembly of claim 1, wherein the pipe segment is fitted with a coupling at least at one end.

11. The pipe segment feed pellet detection assembly of claim 1, wherein the radiation means is configured to illuminate at least partly divergent electromagnetic radiation into the pipe segment hollow interior.

12. The pipe segment feed pellet detection assembly of claim 1, wherein the radiation means is configured to illuminate an essentially collimated beam of electromagnetic radiation into the pipe segment hollow interior, and where the detection means is mounted in the beam path of the essentially collimated beam of electromagnetic radiation.

13. The pipe segment feed pellet detection assembly of claim 1, further comprising a lens mounted in front of the detection means.

14. The pipe segment feed pellet detection assembly of claim 1, wherein the detection means comprises a CCD screen.

15. The pipe segment feed pellet detection assembly of claim 1, wherein the detection means is multispectral or hyperspectral detection means.

16. The pipe segment feed pellet detection assembly of claim 1, wherein the hollow interior of the pipe segment has a rectangular cross section.

17. The pipe segment feed pellet detection assembly of claim 1, wherein the radiation means is configured to radiate at least one of the types of electromagnetic radiation chosen from the group comprising multi-wavelength light, infrared light, ultraviolet light, white light, x-rays and monochromatic light.

18. The pipe segment feed pellet detection assembly of claim 1, further comprising:
additional radiation means, configured to radiate electromagnetic radiation into the pipe segment hollow interior and
additional detection means and configured to detect electromagnetic radiation from the pipe segment hollow interior.

19. The pipe segment feed pellet detection assembly of claim 18, wherein
the additional radiation means is mounted adjacent to the outer surface of the pipe segment wall, and configured to radiate electromagnetic radiation into the pipe segment hollow interior through one or more of the at least one transparent portion of the pipe segment wall,
the additional detection means is mounted adjacent to the outer surface of the pipe segment wall, and configured to detect electromagnetic radiation from the pipe segment hollow interior through one or more of the at least one transparent portion of the pipe segment wall, wherein
the additional radiation means and additional detection means are mounted on at least partially opposite sides of the pipe segment, and are arranged perpendicularly to the arrangement of the radiation means and detection means.

20. A fish feeding system comprising:
an aquaculture system comprising an aquaculture system main tank and an aquaculture system main tank outlet pipe, and
a pipe segment feed pellet detection assembly of claim 1, wherein
the pipe segment feed pellet detection assembly is mounted as a pipe segment of the main tank outlet pipe.

21. The fish feeding system of claim 20, wherein the main tank outlet pipe is branched, and where the pipe segment feed pellet detection assembly is mounted as a pipe segment of a branch of the main tank outlet pipe.

22. The fish feeding system of claim 20, wherein:
a feeder configured to add feed pellets to the aquaculture system main tank, and
a computer at least connected with the pipe segment feed pellet detection assembly and the feeder, configured to instruct the feeder based on at least one input from the pipe segment feed pellet detection assembly.

23. A fish feeding method providing a fish feeding system of claim 22, wherein
providing a fluid flow in the aquaculture system that passes through the pipe segment feed pellet detection assembly,
adding, at a feeding rate by the feeder, feed pellets to the aquaculture system main tank,
radiating, by radiation means of the pipe segment feed pellet detection assembly, electromagnetic radiation into the pipe segment hollow interior,
detecting, by detection means of the pipe segment feed pellet detection assembly, electromagnetic radiation from the pipe segment hollow interior, wherein the step of detecting electromagnetic radiation comprises detection of real space images, reciprocal images or a spectral distribution of electromagnetic radiation,
estimating, by the computer, a number of feed pellets in the fluid flow passing through the pipe segment feed pellet detection assembly, and
instructing, by the computer, the feeder to adjust the feeding rate based on the estimated number of feed pellets.
